(19) United States
(12) Patent Application Publication
(10) Pub. No.: US 2003/0167206 A1
(43) Pub. Date: Sep. 4, 2003

(54) POS terminal system

(75) Inventor: Tomiko Shirai, Maebashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/265,795

(22) Filed: Oct. 8, 2002

(30) Foreign Application Priority Data
Mar. 4, 2002 (JP) 2002-057285

(51) Int. Cl. G06F 17/60

(52) U.S. Cl. 705/16

(57) ABSTRACT

When performing checkout processing for a purchased product at a POS terminal installed in a retail store or the like, service points earned for the total amount of payment for the purchased product and an additional amount of purchase required to earn one more service point are displayed on the customer-side screen of the terminal together with a message enticing the customer to earn one more service point. The customer-side screen includes a section in which purchase guide information about products having prices equal to or higher than the additional amount can be displayed, and “Image 1”, “Image 2”, etc. of such products are displayed in the purchase guide information section. As the additional amount of purchase required and the purchase guide information are automatically displayed, the sales of merchandise can be promoted effectively.

### TECHNICAL FIELD OF THE INVENTION

The present invention relates to a POS terminal system installed in a retail store or the like, and more particularly to a POS terminal system that can automatically display purchase guide information including an additional amount of purchase required to earn an additional service index value for one transaction, and can thus promote the sales of merchandise.

### BACKGROUND RELATED ART

In recent years, retail stores, such as supermarkets, department stores and shopping centers, have been introducing a membership system as part of a customer service system to secure regular customers. When a customer registered with such a membership system purchases a product at a retail store that operates the membership system, service points are calculated for each purchase, based on the sales data of the purchased product, for example, the total amount of the purchase. When the cumulative service points reach a certain target value, the retail store issues, for example, a service coupon or a gift certificate of a certain cash value to the customer, or offers a prescribed prize to the customer, as part of sales promotion service. Here, the service points are calculated based on the total amount of purchase in one transaction of purchased merchandise, and serve as a service index value when the customer receives service such as a price discount or a prize. A service coupon can also serve as the service index value.

In practice, such customer service is provided using a POS terminal installed in a store. The following describes how this is done. First, when the customer is a registered member, the sales clerk operating the POS terminal swipes the customer's membership card through a card reader/writer on the POS terminal to read the card data. Then, using a product entry means such as a keyboard, scanner, or the like attached to the POS terminal, the sales clerk enters the sales data of all the products being purchased by the customer. When the entry of all the purchased products is completed, the sales clerk operates the total key on the input means to conclude the entry.

Next, in the POS terminal, the total amount of payment for the products purchased by the customer is calculated based on the sales data of the products, and service points for the current transaction are calculated based on the total amount. Then, a membership file in which member-related information is stored is accessed to read out the service points accumulated up to the previous transaction for that customer. Then, from the service points earned for the current transaction and the service points accumulated up to the previous transaction, the cumulative service points up to the current transaction are calculated, to determine whether the cumulative service points have reached a target value.

At this time, a display means attached to the POS terminal displays the total amount of the current purchase. The customer views the displayed amount, and pays for the purchase. When the payment is done, the POS terminal automatically issues a receipt on which the amount received and any necessary comment are printed.

Here, the customer receives the receipt from the sales clerk, but by just seeing the receipt, the customer does not know how many services points have been accumulated up to this point in time for the customer. In view of this, provisions are made to print on the receipt the cumulative service points up to the present time together with the amount received and any necessary comment in order to enable the customer to enjoy this service system more effectively or to stimulate customer interest in purchasing.

There are also proposed various methods to present the current status of the cumulative service points in an easy-to-understand manner. For example, it is practiced to issue a receipt by printing thereon not only the cumulative service points but also a bar graph indicating the percentage that the cumulative service points account for with respect to the target value at which a reward offered by the service can be obtained. Further, information of how many more points are needed to reach the target value is also printed on the receipt. It is also practiced to print the current cumulative service points and point shortage information on a slip printed out separately from the receipt.

In these proposed services, however, the status of the cumulative service points, the point shortage information, etc. are presented to the customer after the customer has paid for the purchase. All that the customer knows here is how many more points are needed to get a reward offered by the service, and the information presented is not enough to entice the customer on the spot to purchase a product corresponding to the point shortage. Therefore, the sales clerk has to do appropriate sales promotion verbally by seeing the point shortage information.

This will be described in detail by way of example. A service system is operated in which when a customer makes a purchase at a store such as a fast food store or a clothing store, one service point or one service coupon is issued for every predetermined amount of purchase.

For example, consider the case where when a customer makes a purchase at the store, one service coupon is issued to the customer for every 300 yen of purchase; in this case, if the amount of purchase is 500 yen, the customer will receive one service coupon for the 300 yen, but no service coupon for the remaining 200 yen. Here, the sales clerk does sales promotion, for example, saying to the customer, “If you will make a purchase worth 100 yen or more, you will get a total of two service cards.” For the customer also, if he can make an additional purchase and get service coupons by making efficient use of the 300-yen reference unit, he will feel that he has made a good purchase, and thus the customer is enticed to buy more.

In such a case, the sales clerk informs the customer verbally, but the problem is that if the sales clerk is not accustomed to doing such sales promotion, or if the store is crowded and the sales clerk is busy attending to customers, the sales clerk tends to forget to do the sales promotion.

Next, consider the case of a clothing store or the like where a service system is operated in which one service point is issued for every 2000 yen of purchase and, when the service points reach a certain amount predetermined by the store, a voucher of a certain cash value is issued entitling the customer to get a product worth that cash value. At such a store, for a purchase worth 1800 yen, for example, no service point is issued. In this case, the sales clerk advises the customer to buy something worth 200 yen or more, by making use of the customer's psychology that the customer feels inclined to buy a little more if he can get a service point. On the store side, this serves to increase the sales. However, in this case also, the problem is that the intended effect cannot be achieved unless the sales clerk does sales promotion verbally.

It is accordingly an object of the present invention to provide a POS terminal system that automatically outputs not only purchase information showing the total amount of purchase and the service points earned for the purchase, but also purchase guide information which enables the customer to know how an effective purchase can be made to get one more service card or service point, even when verbal sales promotion is not done by the sales clerk.

### SUMMARY OF THE INVENTION

To solve the above-described problem, according to the present invention, there is provided a POS terminal system comprising an input means for entering information about a product being purchased, a processing means for performing checkout processing for the product being purchased, and a display means for displaying purchased product information showing the results of the checkout processing, wherein the POS terminal system is configured so that a service index value issued for the total amount of payment for the purchased product and an additional amount of purchase required to earn another additional service index value can be presented for display on the display means.

A message containing the additional amount of purchase and recommending that another additional service index value be earned is also displayed on the display means; furthermore, suggested product information about a product whose price is not lower than the additional amount of purchase can be presented for display on the display means, and an image of the product is included in the suggested product information.

Furthermore, the processing means can be configured to output the message by synthesized voice.

### BRIEF DESCRIPTION OF THE DRAWINGS

These and other objects and features of the present invention will become clearer from the following description of the preferred embodiments given with reference to the attached drawings, wherein:

FIG. 1 is a diagram showing a specific example of an image display in a POS terminal system according to the present invention;

FIG. 2 is a block diagram showing the configuration of the POS terminal system according to the present invention;

FIG. 3 is a flowchart for explaining the operations and processing performed in the POS terminal system according to the present invention;

FIG. 4 is a diagram showing a specific example of a customer segment file;

FIG. 5 is a diagram showing a specific example of a product master file;

FIG. 6 is a flowchart for explaining the processing for displaying product information and a product image;

FIG. 7 is a diagram showing a specific example of a price-range-specific product file; and

FIG. 8 is a diagram showing a specific example of a customer-segment- and price-range-specific product file.

### DETAILED DESCRIPTION OF THE INVENTION

An embodiment of a POS terminal system according to the present invention will be described below with reference to the accompanying drawings.

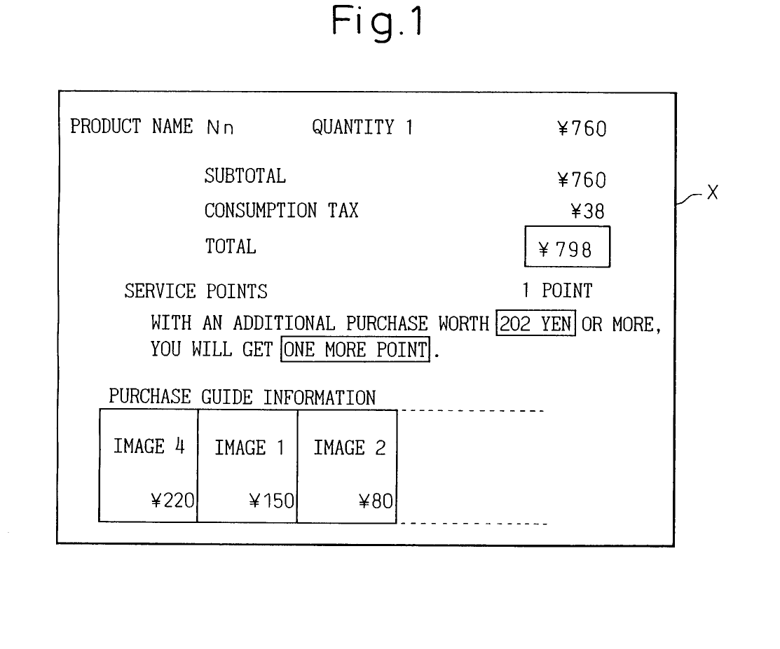

FIG. 1 shows one example of a screen image displayed on a POS terminal of this embodiment, the screen image showing purchase guide information along with purchase information for a purchase made by a customer. The screen image X shown here is displayed on a display means attached to the POS terminal; this display means is provided separately from the display screen that the sales clerk views to confirm the purchase information, and is placed so as to be viewable from the customer. The screen of the display means is constructed, for example, from a color liquid crystal display panel.

The upper half of the screen image X is mainly dedicated to the display of the purchase information which is also printed on a receipt. The purchase information includes the product name, unit price, quantity, and amount of the product purchased, plus the subtotal of the purchase, the amount of consumption tax, the total amount, etc. In the illustrated example, the screen shows that the product name of the purchased product is Nn, its price is 760 yen, the subtotal of the purchase is 760 yen, the consumption tax for it is 38 yen, and the total amount of the purchase is 798 yen. Here, only one purchased item is shown, but if the number of purchased items is more than one, all the purchased items will be shown; if all the purchased items cannot be shown in the display area of the purchase information, only the subtotal for the purchased items may be shown, or alternatively, provisions may be made to display updated product information in the order of entry of the purchased products.

The example of the screen image X shows the case where one service point is issued for every 500 yen; therefore, for the purchase made here, one service point is issued, and “1 point” is displayed in the service point column.

The service point information and the purchase guide information are displayed in the lower half of the screen image X. In the illustrated example, as the total amount of purchase exceeds the point issuing unit amount of 500 yen, one point is issued, but the total amount falls short of the amount required to earn two points; therefore, a message “With an additional purchase worth 202 yen or more, you will get one more point” is displayed as the point information enticing the customer to earn one more point. In FIG. 1, the additional amount of purchase required and the number of points are highlighted. These highlighted portions are each displayed in a box, but may be displayed, for example, in a different color than other portions. In the example of the screen image X, service points are issued based on the total amount including the consumption tax, but alternatively, service points may be issued based on the subtotal of the purchase excluding the consumption tax. In the case of including the consumption tax, “202 yen or more” will be displayed as the additional amount required, and in the case of excluding the consumption tax, it will show “240 yen or more”.

In addition to the point shortage information, and below it, is displayed the purchase guide information. The purchase guide information is for enticing the customer to make an additional purchase worth 202 yen or more including the consumption tax; here, product images are displayed showing suggested products or recommended products for additional purchases. Products whose prices are such that the customer will feel inclined to make an additional purchase worth 202 yen or more are selected for the product images displayed here.

In the example of the screen image X, since the minimum required additional amount is 202 yen, a product whose price of 220 yen alone exceeds the minimum required additional amount is displayed as “Image 4” here. A plurality of products in this price range may be displayed in the form of pictures here. There are, however, cases where the customer does not like the product shown in Image 4; therefore, “Image 1” and “Image 2” showing products whose prices, for example, 150 yen and 80 yen, are each lower than the minimum required additional amount may be displayed so that the customer can select such products whose prices, when combined, exceeds the minimum required additional amount. If these product images are selected by considering customer segment information identifying which customer segment, a housewife, child, company employee, etc., the customer belongs to, guide information that better matches the taste of the customer can be presented.

In this way, when the customer pays for the purchase, as the purchase information, point information, and purchase guide information are automatically displayed on the screen of the display means viewable from the customer, not only can the customer viewing the screen know the amount of payment for the purchase and the status of the service points earned, but customer interest in getting a reward offered by the service is also stimulated by seeing the purchase guide information. As a result, the customer is enticed to make an additional purchase.

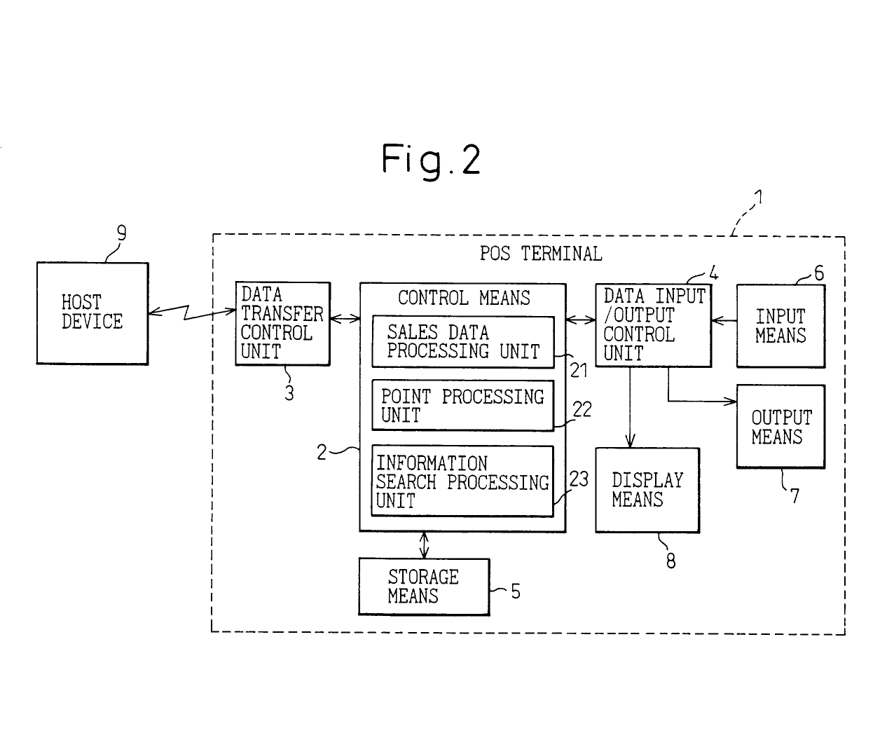

Next, the POS terminal system capable of automatically doing sale promotion when checking out purchases, as illustrated above, will be described with reference to FIGS. 2 to 8.

FIG. 2 is a schematic block diagram showing the configuration of the POS terminal of this embodiment. In the figure, the POS terminal 1 shown within the dashed lines comprises a control means 2, a data transfer control unit 3, a data input/output control unit 4, a storage means 5, an input means 6, an output means 7, and a display means 8. Usually, a plurality of POS terminals 1 are installed in a retail store, and each POS terminal 1 is connected, for example, via a LAN or the like, to a host device 9 which centrally manages the entire store. Data transmission and reception between the host device 9 and each POS terminal is performed via the data transfer control unit 3.

The control means 2 is responsible for the entire management of the POS terminal system, and performs the basic processing operations as the POS terminal. The control means 2 comprises a sales data processing unit 21, which performs processing operations specifically related to the present embodiment, a point processing unit 22, and an information search processing unit 23.

The data input/output control unit 4 controls data transmission and reception between the control means 2 and the input means 6, output means 7, or display means 8. The input means 6, which is operated by a sales clerk, includes a keyboard, a touch panel, a scanner, a card reader/writer, etc. The output means 7 includes a receipt journal, a printer, etc. The display means 5 is preferably equipped with two screens that can be viewed by the sales clerk and by the customer, respectively, or the respective screens may be provided as separate display units. It is understood here that the customer-side screen is capable of displaying the screen image X shown in FIG. 1.

The storage means 5 not only provides an operating memory area necessary for the control means 2 to function as the POS terminal, but also stores various kinds of data such as a customer segment file, a product master file, a product image file, and a price-range-specific file or a customer-segment- and price-range-specific file. These various kinds of data are generated by the host device 9 are transferred on a daily basis or hourly basis to each POS terminal via the data transfer control unit 3. The various kinds of data are then loaded into the storage means 5 to update the previously stored data. The stored data is read out as it is needed for processing in the control means 2.

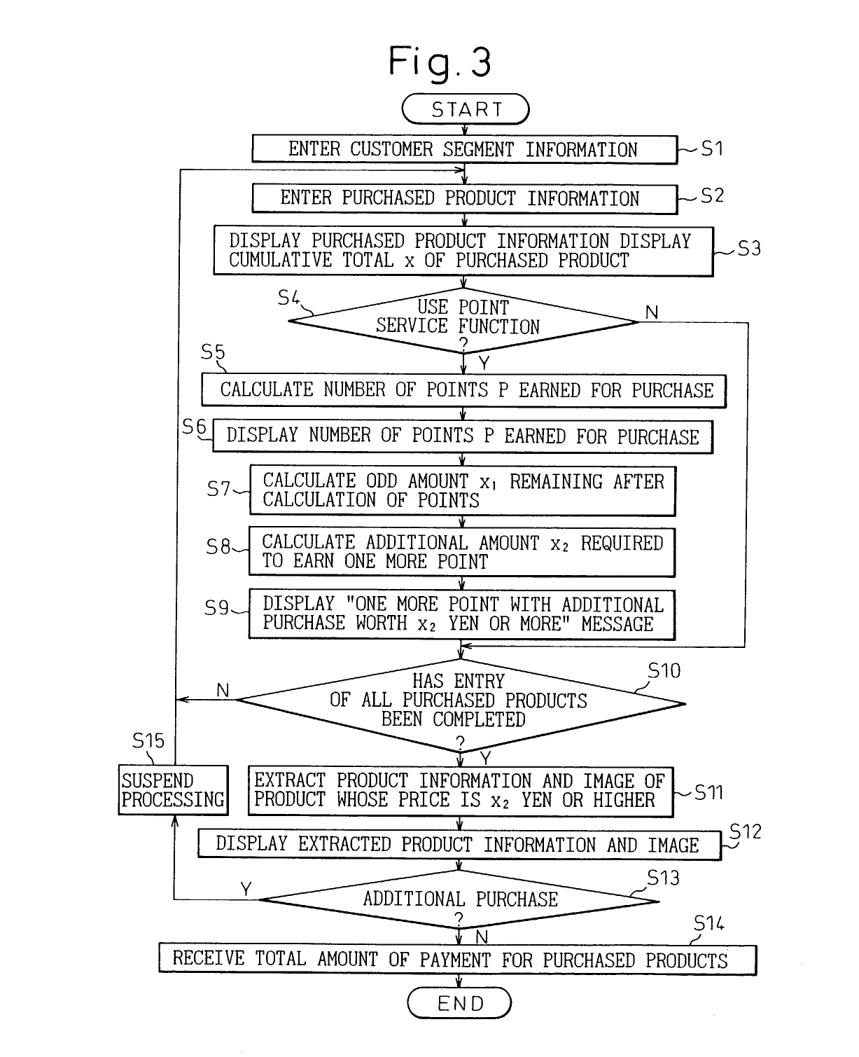

The operations and processing performed in the POS terminal having the above configuration will be described below with reference to the flowchart of FIG. 3.

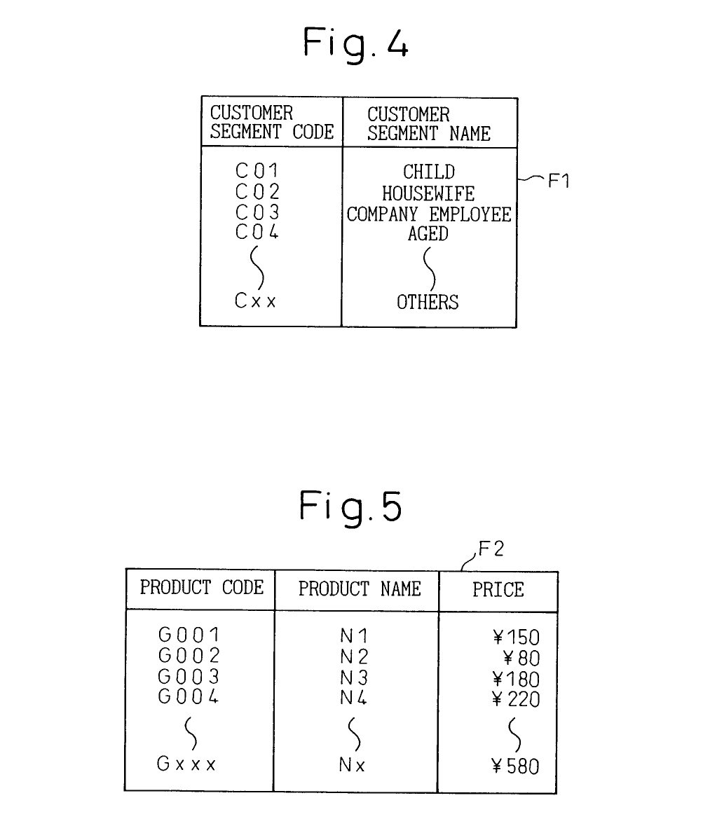

First, consider the case in which a customer who wishes to purchase a product takes the product to a POS terminal where a sales clerk is in attendance, and pays for the purchase. At this time, if it is practiced to also collect customer segment information for the purpose of statistical processing of sales information at the store, the sales clerk enters customer segment information by entering it using the input means 6 such as a keyboard or a touch panel (step S1). As shown in FIG. 4, the customer segment information is stored in the customer segment file F1 with each customer segment name associated with a customer segment code; for example, if a “CHILD” button on the touch panel is pressed, the customer segment code “CO1” is read, and is stored in the storage means 5 by being associated with the purchased product information for that customer.

Next, the sales clerk enters the purchased product information concerning the product being purchased by the customer, that is, the product name and quantity of the product, by entering them using the input means 6 such as the keyboard, touch panel, or scanner (step S2). Suppose, for example, the bar code attached to the product is read using the scanner; in this case, based on the thus read product code, the product name and price of the product are retrieved from the product master file F2 stored in the storage means 5 as shown in FIG. 5.

When the product name and price of the product are retrieved, the sales data processing unit 21 calculates the cumulative total x of the purchased product and the amount of the consumption tax from the price and quantity of the purchased product, and issues an instruction to display the product name, quantity, price, subtotal as the cumulative total x, consumption tax, and total as the purchased product information on the customer-side screen of the display means 8 as shown by the screen image X of FIG. 1 (step S3).

The purchase by the customer is now ready to be settled, so that the sales clerk checks whether the customer is a registered member of the service system (step S4). When the customer has a membership card verifying that he is a registered member, the point service function of the POS terminal system is used (Y), so that the sales clerk swipes the membership card through the card reader/writer of the input means 6 to read the customer code.

When the customer is verified to be a registered member by the control means 2, the point processing unit 22 calculates the number of points P earned for the product purchased by the customer (step S5). The number of points P earned here is computed by calculating (x÷R) and truncating the result to the nearest integer, where R is the point issuing unit amount R stored in the storage means 5.

The number of points P thus computed is displayed on the customer-side screen of the display means 8 (step S6). As in the example of the screen image X shown in FIG. 1, “1 point” is displayed in the service point column. In the illustrated example, the total amount of the purchase is 798 yen, which exceeds the point issuing unit amount R=500; it is therefore shown that one point is earned for the product purchased. Here, the cumulative points Pm earned up to the previous purchase by the customer may be read from the host device 9 based on the customer code, and added to the newly earned point P to compute the current cumulative points Pm. The cumulative points Pm thus computed may be displayed on the customer-side screen.

Next, from the cumulative total x and the point issuing unit amount R, the odd amount x₁ remaining after calculating the point for the purchased product is computed by calculating x₁=x−P·R (step S7). In the example shown in FIG. 1, since P=1, 798−500=298.

Here, the additional amount x₂ required to earn one more service point is expressed by the general equation

x₂=R−x₁=R−(x−P·R)=R(P+1)−x

which, in the example of FIG. 1, is calculated as x₂=202 (step S8).

Then, the point processing unit 22 creates a message “With an additional purchase worth 202 yen or more, you will get one more point” by inserting the 202 yen information in the additional amount portion, and instructs the display means 8 to display the message on the customer-side screen (step S9). The above description has been given by assuming that the cumulative total x, the earned point P, and the minimum required additional amount x₂ are displayed in sequence in the screen image X as they are calculated, but the results of the calculations may be displayed at a time after calculating them together. Further, the message may be created by the control means 2 using a synthesized voice, and produced through a speaker provided in the display means 8.

On the other hand, the sales clerk checks whether all the products being purchased by the customer have been entered (step S10); if there is any product remaining to be entered (N), the process returns to step S2 to perform processing to enter the product. When the message is displayed on the customer-side screen as shown in the screen image X of FIG. 1, the customer viewing the message may feel inclined to make some additional purchase to earn one more service point. Here, the sales clerk may speak to the customer, saying, for example, “Have you purchased all you need?”, thus asking the customer whether the sales clerk may conclude the entry of the purchase.

If, in step S4, the customer is not a registered member (N), the process from step S5 to step S9 is not necessary, so that the process skips to step S10 after carrying out the processing in step S3. In this case, the service point information and the message are not displayed in the screen image X. Instead, a message inviting the customer to join the membership may be displayed.

The sequence of operations from step S2 to step S9 may be performed for each entry of a purchased product, and the contents of the display may be updated each time.

When it is determined in step S10 that entry of all the products have been completed (Y), the total key on the input means 6 is pressed to start the process for closing the transaction for the purchase. The total amount x of the purchase and the minimum required additional amount x₂ can thus be determined tentatively for the customer.

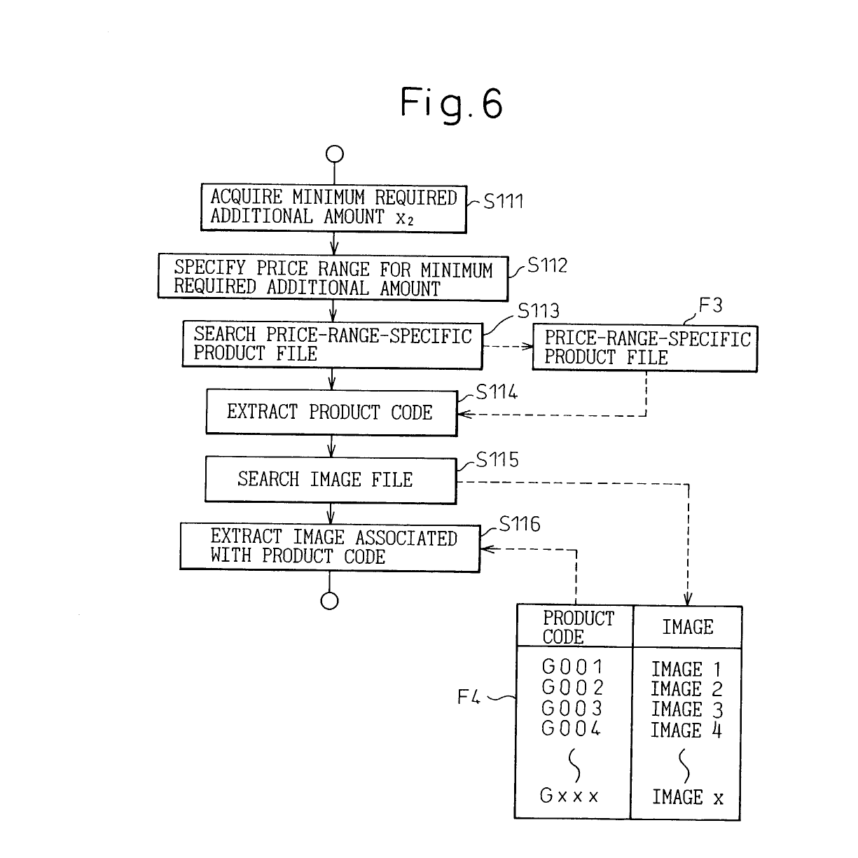

Next, as the minimum required additional amount x₂ has been determined, processing can now be performed to create the purchase guide information as shown in FIG. 1 (step S11), and the purchase guide information can thus be displayed (step S12). The details of step S11 in the flowchart of FIG. 3 are shown in the flowchart of FIG. 6. The process for creation of the purchase guide information will be described with reference to FIG. 6.

First, the information search processing unit 23 acquires the minimum required additional amount x₂ calculated by the point processing unit 22 (step S111). Then, it is determined which predetermined price range the minimum required additional amount x₂ belongs to (step S112). Each price range has a width of 100 yen, for example, and the price range in which the minimum required additional amount falls is obtained here. In the example of FIG. 1, as the minimum required additional amount is 202 yen, the price range of “300 yen or less” is specified by determining that it would be best to select a product that can by itself satisfy the condition.

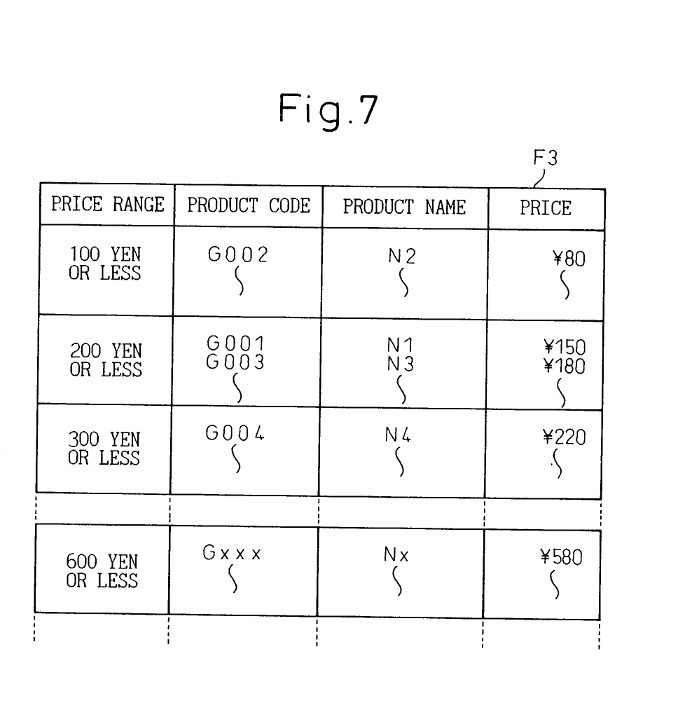

Next, based on the price-range-specific product file F3 shown in FIG. 7, a search is conducted to find what products are available in the specified price range (step S113). The price-range-specific product file F3 stores the product code, product name, and price for each price range. The product name and price need not necessarily be stored in the price-range-specific product file F3, since these can be retrieved from the product master file F2 based on the product code stored in the file F3. It will be advantageous to preferentially store in the price-range-specific product file such products that the store has strategically chosen to sell.

Based on the price-range-specific product file F3, the product code that satisfies the condition of the minimum required additional amount x₂ is extracted (step S114). If there are a plurality of product codes in the same price range, all of such product codes can be retrieved, or the product code of a product whose price exceeds the minimum required additional amount x₂ but is the closest to x₂ can be selectively retrieved. In the example of FIG. 7, the product code G004 is extracted. It is also possible to extract a plurality of product codes in the order of increasing distance from the value of x₂ so as to fit in the size of the purchase guide information section in the screen image X.

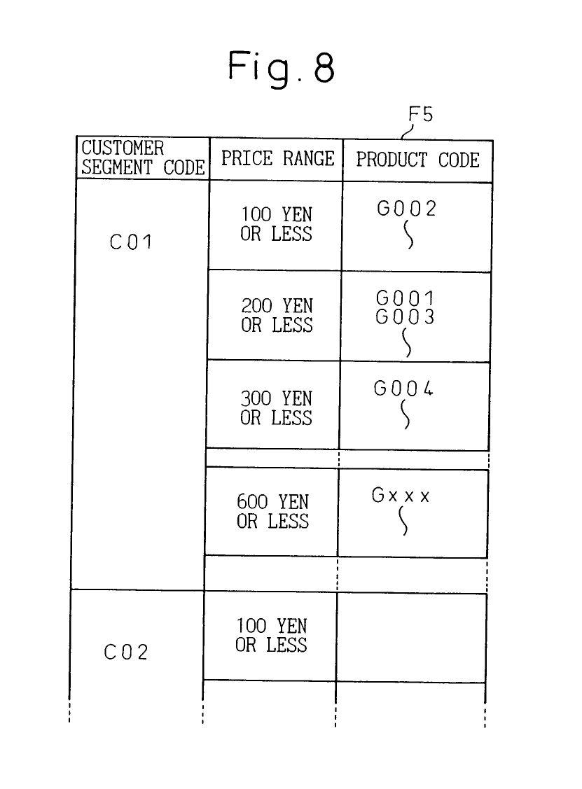

There can, however, be cases where too many product codes are extracted from the price-range-specific product file F3; in view of this, as the customer segment information of the customer is entered in step S1 of FIG. 3, if a customer-segment- and price-range-specific product file such as shown in FIG. 8, for example, is created and stored in the storage means 5 in advance, then product codes that better match the customer's taste and interest can be extracted. The customer-segment- and price-range-specific product file F5 contains a price-range-specific product file for each customer segment. The example shown in FIG. 8 is for the case where the customer is a child, and shows the product codes associated with the customer segment code C01 entered as the customer segment information.

Thus, the product to be displayed for the purchase guide information has been selected. Here, if the product name and its associated price are retrieved from the product master file F2, these can also be displayed in the purchase guide information section in the screen image X.

The storage means 5 stores an image file F4 with images of photographed products associated with the respective product codes. In the image file F4, “Image 1” is stored as image data, for example, for the product code G001, as shown in FIG. 6. Then, the information search processing unit 23 searches through the image file F4 by reference to the product code extracted in step S114 (step S115).

If the corresponding product code is found in the image file F4, the image data associated with the product code is extracted (step S116).

Since the product information concerning the product and its image data that can be presented as the purchase guide information have been extracted as described above, these are displayed in the purchase guide information section in the screen image X shown in FIG. 1 (step S12 in FIG. 3). The purchase guide information can be displayed, for example, by superimposing the product information (product name or price) on the picture produced from the image data. If the image data corresponding to the extracted product code is not found in the image file F4, only the product information may be displayed in the purchase guide information section without displaying the image.

The screen image X shown in FIG. 1 is thus displayed on the customer-side screen of the display means 8. The customer viewing this screen not only realizes that an additional purchase worth 202 yen would earn one more point, but also sees the purchase guide information. The customer then decides whether to make an additional purchase or not (step S13).

If there is no additional product the customer desires to buy, or the customer has no interest in earning one more service point (N), the customer pays for the purchase, and the sales clerk receives the total amount x for the purchased product from the customer (step S14).

On the other hand, if the customer viewing the customer-side screen would like to take the opportunity to earn one more point, or to buy a desired product by taking that option, the customer makes an additional purchase (Y in step S13).

Upon request from the customer, the sales clerk suspends the entry process for the purchase being processed (step S15). The suspension of the entry process is accomplished by operating the hold key on the input means 6. When the hold key is pressed, the checkout process for that customer is suspended, so that the entry process for the next customer waiting in line can be performed.

After the entry process has been suspended, when the customer brings the additional product to purchase, the sales clerk operates the hold key to resume the suspended entry process, that is, the process returns to step S2 to register the additionally purchased product. The process thereafter is the same as the entry process described above.

The above embodiment has been described by taking the service point as an example of the service index value, but the embodiment can also be applied when issuing a service coupon. In that case, the number of coupons is displayed instead of the number of points in the screen image X of FIG. 1, and the guide information showing the image, product name, or price of a product suggested for purchase to earn one more service coupon is displayed in the purchase guide information section.

The above embodiment uses a POS terminal system that automatically outputs purchase guide information for sales promotional purposes, but the system according to the above embodiment can also be applied to mail order service, such as Internet shopping, that uses a communication terminal, for example, a personal computer, portable information apparatus, etc. connected to a network; in that case also, sales promotional information and purchase guide information can be automatically output on the display screen of the communication terminal. This can be accomplished by displaying on the display screen of the communication terminal the same image as that displayed on the customer-side screen of the display means attached to the POS terminal.

As described above, according to the present invention, provisions are made in the POS terminal system to display not only purchased product information such as product name and total amount of purchase for the product being purchased by a customer, but also the service index value, i.e., the number of service points or service coupons, that can be earned with the total amount of the purchase, along with a message concerning an additional amount required to earn one more service point or service coupon. Further, a product image and product information concerning a product worth the minimum required additional amount are automatically displayed as purchase guide information on the screen on which the above message is displayed.

In the prior art, the total amount of purchase has been displayed for viewing by the customer but information such as the number of service cards earned, a recommend product to earn one more card, etc. has not been displayed for viewing by the customer but has only been given verbally by the sales clerk; in contrast, according to the present invention, as the message and the purchase guide information are displayed together with the purchased product information for viewing by the customer when checking out the purchased products, if the sales clerk is unable to do sales promotion for some reason, sales promotion activity can be performed more effectively and efficiently, enticing the customer into purchasing.

Furthermore, since the product image and product information of each individual product can be shown on the screen of the display unit, the sales clerk can offer a suggestion to the customer, saying, for example, “How about this product?”. In the case of a clothing store or the like, since it becomes possible to offer a recommended product that matches the customer segment, this serves to help the sales promotion activity of the sales clerk.

In this way, according to the present invention, the promotion of sales to the customer can be done automatically, and this leads to increased sales at the store. This also contributes to enhancing customer satisfaction.

While the invention has been described with reference to specific embodiments chosen for purpose of illustration, it should be apparent that numerous modifications could be made thereto by those skilled in the art without departing from the basic concept and scope of the invention.

The present disclosure relates to subject matter contained in Japanese Patent Application No. 2002-57285, filed on Mar. 4, 2002, the disclosure of which is expressly incorporated herein, by reference, in its entirely.

What is claimed is:

1. A POS terminal system comprising an input means for entering information about a product being purchased, a processing means for performing checkout processing for said product being purchased, and a display means for displaying purchased product information showing the results of said checkout processing, wherein
said display means displays a service index value issued for the total amount of payment for said purchased product and an additional amount of purchase required to earn another additional service index value.

2. A POS terminal system according to claim 1, wherein said display means displays a message containing said additional amount of purchase and recommending that another additional service index value be earned.

3. A POS terminal system according to claim 1 or 2, wherein said display means displays suggested product information about a product whose price is not lower than said additional amount of purchase.

4. A POS terminal system according to claim 3, wherein said display means displays an image of said product as part of said suggested product information.

5. A POS terminal system according to claim 2, wherein said processing means outputs said message by synthesized voice.

6. A POS terminal system according to claim 1, wherein said processing means, based on the total amount of payment for said purchased product, calculates said service index value by reference to a predetermined amount, and calculates the additional amount of purchase required to earn another additional service index value by dividing said total amount by said predetermined amount and subtracting the resulting remainder from said predetermined amount.

7. A POS terminal system according to claim 3, wherein said suggested product information is generated by extracting said product from a price-range-specific product file in accordance with said additional amount of purchase.

8. A POS terminal system according to claim 3, wherein said suggested product information is generated by extracting said product from a customer-segment- and price-range-specific product file in accordance with said additional amount of purchase.

9. A POS terminal system according to claim 7 or 8, wherein said image included in said suggested product information is extracted from an image file in accordance with said extracted product.

10. A POS terminal system according to claim 1, wherein if there occurs an additional purchase to be made, said processing means can suspend the checkout processing of said product being purchased.

11. A POS terminal system according to claim 10, wherein when entering purchased product information about said additional purchase, said processing means resumes said suspended checkout processing and performs the checkout processing for all the products being purchased.
